(19) United States
(12) Patent Application Publication
(10) Pub. No.: US 2026/0245108 A1
(43) Pub. Date: Aug. 20, 2026

(54) SYSTEMS AND METHODS FOR PREDICTING DEMAND IN REAL ESTATE SALES

(71) Applicant: Real Estate Analytics Pte. Ltd., Singapore (SG)

(72) Inventors: Jean-Michel Jean-Marie Louis Sebastien PAUL, Singapore (SG); Yanjing WU, Singapore (SG)

(73) Assignee: Real Estate Analytics Pte. Ltd., Singapore (SG)

(21) Appl. No.: 19/059,156

(22) Filed: Feb. 20, 2025

(51) Int. Cl. G06Q 30/0202; G06Q 30/0201; G06Q 50/16

(52) U.S. Cl. CPC G06Q 30/0202; G06Q 30/0206; G06Q 50/16

(57) ABSTRACT

Systems and methods for predicting demand in real estate sales receive project-specific input data such as launch pricing, unit mix, project configuration, location factors, and/or market dynamics; identify comparable real estate projects within a defined geographic range based on similarity of project size, configuration, and/or launch conditions; apply an Initial Timeframe Model to forecast the number of units likely to sell within a first timeframe after launch, using a comparative analysis of the identified comparable projects and the project-specific input data; generate a project-specific demand curve for a subsequent timeframe using a demand curve model in which the model establishes a relationship between unit pricing and demand; dynamically refining the demand curve by incorporating real-time market data and/or housing market trends to align predictions with current economic conditions; and provide a graphical representation of the demand curve to guide optimal pricing and sales strategies for sustained revenue generation.

### CROSS-REFERENCE TO RELATED APPLICATIONS

No cross-reference is presented at this time.

### BACKGROUND

Traditional demand forecasting methods in real estate are plagued by several technical limitations that hinder their accuracy and applicability to new developments. One major challenge is the reliance on historical sales data, which assumes that past market conditions and buyer behaviors will remain consistent over time. However, real estate markets are inherently dynamic, influenced by factors such as economic shifts, interest rate fluctuations, regulatory changes, and evolving consumer preferences. These external variables are not adequately accounted for in conventional models, leading to inaccurate predictions when applied to new projects with unique attributes.

Another significant limitation is the static nature of comparative market analyses (CMAs), which form the backbone of many traditional forecasting systems. CMAs typically compare a subject property to recently sold properties within a geographic area based on basic attributes such as square footage, location, and price. However, this approach does not factor in nuanced differences between projects, such as variations in unit configurations, amenities, financing options, or developer reputation. Moreover, CMAs do not provide predictive insights but rather retrospective assessments, making them ineffective for real-time pricing and demand optimization.

Furthermore, existing demand prediction techniques often fail to incorporate real-time market dynamics and buyer sentiment analysis. Many forecasting models use predefined metrics and static coefficients that do not adapt to ongoing changes in the market. For instance, if a competing development launches with aggressive pricing or an economic downturn affects buyer confidence, these factors may significantly impact demand but will not be reflected in static forecasting models. The lack of adaptive mechanisms prevents developers from making timely, data-driven adjustments to their sales and pricing strategies.

Another technical shortcoming arises from the inability to accurately model price elasticity in the real estate sector. Traditional models generally assume linear or simplistic demand-price relationships without accounting for variations in buyer behavior across different price points, neighborhoods, and market conditions. In reality, demand for real estate is highly nonlinear and context-dependent, influenced by psychological price thresholds, financing incentives, and supply constraints. Existing methodologies lack the computational sophistication required to dynamically adjust pricing strategies in response to real-time demand signals.

Finally, scalability and computational efficiency present technical barriers in existing demand prediction methods. Many real estate analytics tools rely on manual data aggregation, static spreadsheets, or outdated statistical models that are ill-equipped to process large datasets efficiently. As real estate markets expand and generate increasing volumes of transactional and behavioral data, traditional systems struggle to integrate multiple data sources, including national economic indicators, regional housing trends, and buyer demographics. The inability to scale predictions with high-dimensional data severely limits the accuracy and practical utility of current demand forecasting techniques.

### SUMMARY

Aspects of the disclosure relate to systems and methods for predicting demand in real estate sales.

In some aspects, the techniques described herein relate to a computer-implemented method for predicting demand in real estate sales, the method including: receiving project-specific input data including at least one of launch pricing, unit mix, project configuration, location factors, or market dynamics; identifying comparable real estate projects within a defined geographic range based on similarity in at least one of project size, configuration, or launch conditions; applying an Initial Timeframe Model to forecast the number of units likely to sell within a first timeframe after launch, using a comparative analysis of the identified comparable projects and the project-specific input data; generating a project-specific demand curve for a subsequent timeframe using a demand curve model, wherein the model establishes a relationship between unit pricing and demand by iteratively analyzing data from the comparable projects and adjusting for at least one of geographic or demographic variables; dynamically refining the demand curve by incorporating at least one of real-time market data or housing market trends to align predictions with current economic conditions; and providing a graphical representation of the demand curve to guide optimal pricing and sales strategies for sustained revenue generation.

In some aspects, the techniques described herein relate to a method, wherein the project-specific input data further includes details about proximity to at least one of public transportation, schools, or other key amenities.

In some aspects, the techniques described herein relate to a method, wherein the Initial Timeframe Model implements outlier detection to exclude anomalous data from the comparative analysis.

In some aspects, the techniques described herein relate to a method, wherein the demand curve model utilizes a dynamic fitting algorithm that gradually expands the search radius for comparable projects while iteratively refining the data set by excluding statistically irrelevant outliers.

In some aspects, the techniques described herein relate to a method, wherein the demand curve is adjusted to reflect macroeconomic indicators, including at least one of interest rates, inflation, or housing demand trends.

In some aspects, the techniques described herein relate to a method, wherein the project-specific demand curve includes separate sub-curves for different unit types.

In some aspects, the techniques described herein relate to a method, wherein the graphical representation of the demand curve is interactive, enabling real estate developers to simulate the effects of varying price points on projected demand.

In some aspects, the techniques described herein relate to a method, wherein the Initial Timeframe Model predicts sales performance based on the competitive landscape, including the supply and pricing of similar projects launched within a six-month period prior to the subject project.

In some aspects, the techniques described herein relate to a method, wherein the demand curve model incorporates adjustments for seasonality trends in real estate sales to improve demand forecasting accuracy.

In some aspects, the techniques described herein relate to a method, further including continuously updating the demand curve using one or more machine learning techniques as at least one of new sales or market data become available.

In some aspects, the techniques described herein relate to a method, further including generating a comprehensive report summarizing at least one of predicted sales rates, demand curve insights, or recommended pricing strategies.

In some aspects, the techniques described herein relate to a method, wherein the first timeframe after launch is at least one of a first day, a first week, a first weekend, a first month, or a first defined period of time.

In some aspects, the techniques described herein relate to a method, wherein the subsequent timeframe is at least one of a second day, a second week, a second weekend, a second month, multiple subsequent months, or a second predefined period of time.

In some aspects, the techniques described herein relate to a method, further including the integrating real estate market data, including at least one of the number of visitors to open house events, agent and agency commission structures, or online real estate search trends.

In some aspects, the techniques described herein relate to a method, wherein the method extends beyond residential real estate to commercial, industrial, and mixed-use developments, incorporating specific market dynamics for each segment.

In some aspects, the techniques described herein relate to a method, further including a best-selling path optimization module that utilizes the demand curve, real-time market data, and historical transaction trends to determine the optimal sequence of unit releases, pricing adjustments, and promotional strategies to maximize revenue and sales velocity.

In some aspects, the techniques described herein relate to a method, further including an automated scenario analysis engine that evaluates different unit mix configurations, price segmentation strategies, and incentive structures to identify the most profitable development plan based on projected demand and competitor benchmarking.

In some aspects, the techniques described herein relate to a method, wherein the optimization strategy is customized to align with developer-specific objectives, such as achieving a target sales percentage within a predefined timeframe, maintaining price stability without reductions, or maximizing long-term revenue potential.

In some aspects, the techniques described herein relate to a system for predicting demand in real estate sales, including: memory storing computer program instructions; and one or more processors configured to execute the computer program instructions to: receive project-specific input data including at least one of launch pricing, unit mix, project configuration, location factors, or market dynamics; identify comparable real estate projects within a defined geographic range based on similarity in at least one of project size, configuration, or launch conditions; apply an Initial Timeframe Model to forecast the number of units likely to sell within a first timeframe after launch, using a comparative analysis of the identified comparable projects and the project-specific input data; generate a project-specific demand curve for a subsequent timeframe using a demand curve model, wherein the model establishes a relationship between unit pricing and demand by iteratively analyzing data from the comparable projects and adjusting for at least one of geographic or demographic variables; dynamically refine the demand curve by incorporating at least one of real-time market data or housing market trends to align predictions with current economic conditions; and provide a graphical representation of the demand curve to guide optimal pricing and sales strategies for sustained revenue generation.

In some aspects, the techniques described herein relate to a non-transitory computer readable medium having instructions recorded thereon for predicting demand in real estate sales, the instructions when executed by a computer having at least one programmable processor cause operations including: receiving project-specific input data including at least one of launch pricing, unit mix, project configuration, location factors, or market dynamics; identifying comparable real estate projects within a defined geographic range based on similarity in at least one of project size, configuration, or launch conditions; applying an Initial Timeframe Model to forecast the number of units likely to sell within a first timeframe after launch, using a comparative analysis of the identified comparable projects and the project-specific input data; generating a project-specific demand curve for a subsequent timeframe using a demand curve model, wherein the model establishes a relationship between unit pricing and demand by iteratively analyzing data from the comparable projects and adjusting for at least one of geographic or demographic variables; dynamically refining the demand curve by incorporating at least one of real-time market data or housing market trends to align predictions with current economic conditions; and providing a graphical representation of the demand curve to guide optimal pricing and sales strategies for sustained revenue generation.

Various other aspects, features, and advantages will be apparent through the detailed description and the drawings attached hereto. It is also to be understood that both the foregoing general description and the following detailed description are exemplary and not restrictive of the scope of the disclosure.

### BRIEF DESCRIPTION OF THE FIGURES

FIG. 1 depicts an illustrative system for predicting demand in real estate sales, in accordance with at least one embodiment

FIG. 2 depicts an example method for predicting demand in real estate sales, in accordance with at least one embodiment;

FIG. 3 depicts a representative demand curve interface in accordance with at least one embodiment;

FIG. 4 depicts an example computer system on which systems and methods described herein may be executed, in accordance with at least one embodiment.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

In the following description, for the purposes of explanation, numerous specific details are set forth in order to provide a thorough understanding of the various embodiments. It will be appreciated, however, by those having skill in the art, that the embodiments may be practiced without these specific details, or with an equivalent arrangement. In other cases, well-known structures and devices are shown in block diagram form in order to avoid unnecessarily obscuring the embodiments.

To mitigate the problems described herein, the inventors had to both invent solutions and, in some cases just as importantly, recognize problems overlooked (or not yet foreseen) by others in the field. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Embodiments of the present invention introduce a real estate demand forecasting system that overcomes the limitations of traditional static models by employing a dual-model predictive approach: an Initial Timeframe Model (ITM) and a Subsequent Timeframe Demand Curve Model (DCM). Embodiments leverage machine learning algorithms, dynamic comparative analysis, and real-time market adjustments to provide more accurate and adaptive sales rate and demand predictions than conventional techniques. By integrating supervised learning, comparative market analytics, and real-time data ingestion, embodiments of the systems and methods described herein enable users, e.g., real estate developers, to predict sales performance with greater precision. The Initial Timeframe Model forecasts early-stage demand by estimating the number of units likely to be sold within the first timeframe after launch, incorporating a comparative market analysis algorithm that identifies and ranks comparable real estate projects, e.g., using a weighted k-nearest neighbors (k-NN) algorithm. In some embodiments, the model may assign similarity scores based on unit mix, tenure type, launch pricing, and/or location factors, ensuring that only statistically relevant comparable projects are utilized in predictions.

To refine early sales rate predictions, in some embodiments, the model may employ a regression-based predictive system, utilizing machine learning techniques such as XGBoost or Random Forest Regression to analyze historical sales data and predict early-stage sales velocity. The may model further adjust demand forecasts based on launch pricing elasticity and incorporates outlier detection, e.g., using an Isolation Forest algorithm, to exclude extreme values that might skew projections. The systems and methods described herein may dynamically integrate real-time economic indicators, online search trends, and social sentiment analysis to adjust predictions in response to external market fluctuations. When external market shocks occur, such as changes in interest rates, a Bayesian update mechanism or other algorithm may recalibrate the model's forecast confidence intervals to ensure predictions remain aligned with actual market conditions.

The Subsequent Timeframe Demand Curve Model projects demand over an extended timeframe, such as multiple months, by establishing a dynamic relationship between pricing and unit absorption rates. Unlike conventional models that assume linear price-demand relationships, embodiments of the invention leverage adaptive machine learning algorithms to refine demand predictions continuously. The system and methods may incorporate a demand-price function constructed using historical data from comparable projects, employing a piecewise linear regression model to detect psychological pricing thresholds where significant drops in demand occur beyond specific price points. In some embodiments, the demand curve may be further refined through Gaussian Process Regression (GPR), which smooths data and enhances prediction stability.

To ensure real-time adaptability, various embodiments may integrate a Market Signal Processing and Adaptive Learning (MSPAL) engine that continuously monitors transactional data and competitor pricing movements. This component may utilize a filter, e.g., a Kalman filter, to dynamically adjust demand predictions, enabling responsiveness to new sales data and shifting market trends. Additionally, the systems and methods may incorporate search query trends, agent listings, and/or buyer sentiment analysis from social media sources to refine demand forecasts further. To prevent artificially inflated projections caused by speculative investor activity, embodiments may implement an Outlier Detection and Correction Module (ODCM), which applies statistical anomaly detection techniques to exclude abnormal sales figures. The ODCM clusters unit sales patterns using density-based spatial clustering of applications with noise (DBSCAN) clustering algorithm, differentiating between typical buyer behavior and speculative investments.

In some embodiments, an Automated Scenario Analysis Engine (ASAE) may be implemented, which runs thousands of simulations, e.g., Monte Carlo simulations, to evaluate the effects of different pricing strategies, marketing initiatives, and economic conditions on demand forecasts. This feature may allow developers to experiment with unit mix configurations, limited-time discounts, and phased price increases to determine the most profitable sales strategy before implementation. To enhance usability, embodiments may provide a real-time interactive demand curve visualization module, allowing developers to explore pricing simulations and assess buyer sensitivities to different price thresholds. In some embodiments, the graphical interface may feature an interactive heatmap overlay, which highlights optimal pricing regions to maximize revenue.

Embodiments of the invention further optimize unit releases and pricing adjustments through a Best-Selling Path Optimization Module (BSPO), which applies dynamic programming techniques to determine the optimal sequence of unit releases, pricing adjustments, and promotional strategies. This may enable developers to maximize revenue while avoiding sudden inventory surpluses or shortages. By incorporating real-time macroeconomic indicators, interest rate fluctuations, and government policy shifts, embodiments of the systems and methods ensure that demand projections remain relevant despite broader economic changes. Unlike traditional demand forecasting models that rely on static historical data, the present invention dynamically adapts to evolving market conditions, integrating real-time updates to ensure greater predictive accuracy.

Through its adaptive demand curve refinement, iterative learning models, and real-time market integration, embodiments of the invention significantly outperform conventional demand prediction techniques. Embodiments eliminate reliance on outdated historical sales data, incorporate real-time market intelligence, automate demand curve adjustments, and enable predictive simulations to reduce financial risk. The ability to process vast datasets in real time allows developers to assess multiple pricing scenarios and demand sensitivities without relying on static spreadsheets or general market reports. By leveraging advanced predictive modeling, dynamic market integration, and AI-driven analytics, the invention provides a comprehensive, real-time solution for optimizing real estate sales strategies with unparalleled accuracy and efficiency.

Embodiments of the systems and methods described herein minimize processing power and data storage requirements while achieving enhanced predictive accuracy through a combination of data-efficient modeling techniques, hierarchical computational processing, and dynamic memory allocation strategies. Unlike traditional demand forecasting systems that require vast amounts of historical data storage and complex computational processes to analyze demand patterns, the present invention optimizes computational and memory efficiency through a series of algorithmic enhancements and system architectures.

In some embodiments, a key aspect of minimizing processing power is the use of progressive data filtering techniques to ensure that only the most relevant data points are retained for analysis. Traditional models require storage and computation on all available historical transaction records, often leading to redundant processing cycles and excessive memory consumption. In contrast, embodiments of the present invention employ feature selection and dimensionality reduction techniques, such as Principal Component Analysis (PCA) and Recursive Feature Elimination (RFE), to identify and retain only the most predictive variables while discarding extraneous or highly correlated data points. This reduces the number of computations required per prediction, improving efficiency without sacrificing accuracy.

Another improvement over conventional methods is the implementation, in some embodiments, of a tiered computational architecture, which separates lightweight, frequently accessed computations from heavier, infrequent model updates. The system may employ a two-stage approach: first, an on-device edge computing model processes recent real estate transactions, buyer sentiment, and search trends in real-time using incremental learning techniques such as online gradient descent and adaptive boosting (AdaBoost). These techniques allow for continuous model refinement without requiring full retraining, reducing the computational burden associated with batch learning. Second, a cloud-based hierarchical model processing layer periodically consolidates large datasets and performs deep learning model adjustments, ensuring that long-term demand trends are incorporated into the predictive framework without overwhelming local processing resources.

In some embodiments, the system further reduces processing and storage requirements by leveraging probabilistic data structures and efficient indexing methods. Unlike traditional database-driven models that require full dataset retrieval for query execution, in some embodiments, the invention employs tools such as Bloom filters and locality-sensitive hashing (LSH) to enable rapid approximate nearest-neighbor searches without requiring full dataset scans. This is particularly beneficial in comparative market analysis, where the system identifies relevant real estate projects without iterating through the entire dataset, thereby reducing query execution time and minimizing RAM consumption.

Additionally, in some embodiments, incremental data updating mechanisms allow the model to adapt without storing excessive historical data. Instead of requiring continuous access to large-scale sales datasets, the system implements data streaming architectures, wherein new transactions are processed as they occur, updating existing models in a resource-efficient manner. Sliding window approaches and exponential moving averages ensure that only the most recent and relevant sales data contribute to current predictions, significantly reducing the storage overhead while maintaining model accuracy.

In some embodiments, the system may also incorporate lossless compression algorithms and hybrid storage techniques to further reduce memory consumption. Traditional systems store redundant transaction data for extensive periods, leading to inefficient use of disk space and increased access latency. Embodiments of the invention minimize this by using variable-length encoding and run-length compression algorithms to store transaction records efficiently. Additionally, the system may selectively store high-resolution demand curve data only for projects that are actively being analyzed, while archiving lower-resolution historical data for projects that are no longer in development. This hybrid approach ensures that memory is allocated dynamically based on the relevance and recency of data, reducing overall storage requirements.

Another significant efficiency improvement comes from the asynchronous and parallel processing capabilities integrated into the system. Traditional demand forecasting models often rely on sequential data retrieval and computation processes, leading to bottlenecks in execution time. Embodiments of the present invention, however, may employ multi-threaded processing pipelines and distributed computing frameworks such as Apache Spark or TensorFlow Distributed Execution, which allow model components to operate independently and simultaneously. For instance, demand curve recalibration can occur in the background while real-time pricing adjustments are being computed, significantly improving system responsiveness without increasing processing costs.

Furthermore, embodiments of the invention minimize redundancy in demand curve generation by using cache-aware demand prediction algorithms that store and reuse intermediate computations when analyzing similar projects. Instead of recomputing demand projections from scratch for every query, the system precomputes and caches partial demand curves, retrieving and adjusting them dynamically as new market data arrives. This allows for instantaneous adjustments to pricing strategies without requiring full model recomputation, thereby reducing both processing time and energy consumption.

Through these innovative architectural and algorithmic enhancements, the present invention achieves efficiencies in processing power and data storage that are not possible in existing real estate demand forecasting methods. By reducing computational overhead through feature selection, leveraging real-time incremental learning, employing probabilistic data structures for efficient search, implementing compression and hybrid storage techniques, and enabling parallel execution, the system provides an unprecedented level of efficiency in predictive modeling. This allows real estate developers to access high-precision demand forecasts in real time without incurring the high computational costs and memory burdens typically associated with large-scale market analysis.

Those with skill in the art will appreciate that inventive concepts described herein may work with various system configurations. In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device, or a signal transmission medium), and may include a machine-readable transmission medium or a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions. These and other features are described in detail herein with reference to the foregoing figures.

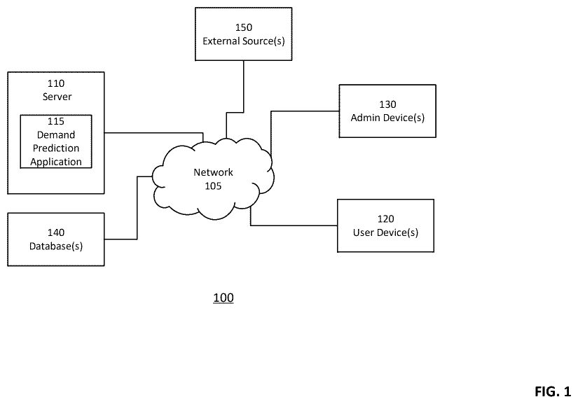

FIG. 1 depicts an illustrative system 100 for predicting demand in real estate sales, in accordance with at least one embodiment. FIG. 1 illustrates a functional block diagram of an embodiment of a demand prediction system 100 within which at least some of the disclosed techniques may be implemented. The demand prediction system 100 may implement various methods and functionalities, as described herein.

In some embodiments, various devices and applications described herein may be configured to communicate via network 105. In some embodiments, computing devices and servers described herein may communicate over network 105, which, in various embodiments, may be any of a diverse range of networks, each tailored to specific needs: Local Area Networks (LANs) linking devices within a confined area such as a home or office; Wide Area Networks (WANs) connecting devices across larger geographical areas, such as cities or countries; Metropolitan Area Networks (MANs) serving as intermediaries, connecting LANs within a city or region; wireless networks; cellular networks; Storage Area Networks (SANs); and/or Virtual Private Networks (VPNs) secure data over public networks. In some embodiments, network 105 may be any combination of the above, which may be a combination of private and public networks.

In some embodiments, each of the elements of demand prediction system 100 may be or may include applications executed on respective computing systems, though this need not always be the case. In some examples, one or more of the applications may be executed on a single computing system (which is not to suggest that such a computing system may not include multiple computing devices or nodes, or that each computing device or node need be co-located; indeed, a computing system including multiple servers that house multiple computing devices may be operated by a single entity and the multiple servers may be distributed, e.g., geographically). For example, in some embodiments, an entity may execute, on a server or other computing system, e.g., server 110, a demand prediction application, e.g., demand prediction application 115. Moreover, in some examples, the entity may also provide users access to a demand prediction application on various user devices (e.g., devices 120 and/or130, described herein), which may be a web-based application hosted by a computing system managed by or provisioned by the entity, or which communicates with such a computing system via an application programming interface (API). Accordingly, one or more of the devices/systems/elements depicted herein may communicate with one another via messages transmitted over network 105, such as the Internet and/or various other local area networks. For example, one or more applications may communicate via messages transmitted over network 105.

In some example embodiments, server 110 may include, host, or otherwise execute demand prediction application 115. In some embodiments, demand prediction application 115 may be a user facing application with which a user interfaces to access various aspects of the systems and methods described herein. For example, one or more users may use one or more user devices 120, e.g., to input data (e.g., text or other inputs), e.g., responsive to requests for such data. For example, in the context of a demand prediction system, users may have various interactions with server 110. In some embodiments, server 110 may integrate with various enterprise systems to implement various features of the demand prediction application.

Accordingly, in various embodiments, users may access user devices 120 to input or otherwise provide data and other information into server 110. For example, users may query demand prediction application 115, or otherwise interact with the platform. Similarly, in some embodiments, administrators and/or other managers within an entity or organization may use admin devices 130 to input data and other information, e.g., with respect to the system, its various users and settings, etc. For example, admin users, e.g., from internal audit, compliance, or IT departments, may be responsible for managing and/or configuring the system. One or more of these users may be more focused on the quality of data entered into the system, and the overall efficiency of the system. For example, such users may set up the system's monitoring parameters and control rules, defining what types of information the system should focus on, what kinds of inputs are sufficiently responsive to queries, etc. In some embodiments, admin users may establish thresholds (e.g., quality control standards, unusual data entries, etc.) and determine how the system flags certain data, activities, etc., ensuring that it aligns with organizational policies and compliance frameworks. In some embodiments, admin users may maintain and adjust the system as the organization evolves. They may respond to feedback from end users by fine-tuning the parameters to refine qualitative responses, reduce false positives or other errors. Admins may also integrate new data sources, adjust control rules as regulations change, or introduce new controls as needed. In some embodiments, demand prediction application 115 may include a user interface through which a user may interact with controls management system 100 via various user devices, e.g., devices 120 and/or 130, and vice versa.

In some example embodiments, demand prediction application 115 may be configured to coordinate with database(s) 140 and/or external source(s) 150. Database 140 may be one or a collection of databases, configured to collect data relating to server 110 and demand prediction system 100.

In some embodiments, external sources 150 may be any external source with which demand prediction application 115 may be configured to interact, e.g., external LLMs, Generative AI models, APIs, other organizations or databases, or even other separate systems within an organization, etc.

The demand prediction application may integrate with various external systems, platforms, and/or third-party data sources through APIs, cloud-based services, and real-time data exchange mechanisms. These integrations may enhance the system's accuracy, scalability, and usability for real estate developers, investors, and other stakeholders. The system may communicate with real estate marketplaces and multiple listing services (MLS) to access real-time property listings, sales transactions, and market trends. APIs from real estate platforms and regional MLS databases may be used to continuously update pricing trends, property availability, and listing performance. This integration allows the demand prediction application to refine its models by incorporating the most up-to-date sales data and property attributes.

The system may also interface with financial and mortgage lending platforms to incorporate interest rate fluctuations, mortgage approval rates, and loan availability into its predictive models. By leveraging APIs from institutions such as Fannie Mae, Freddie Mac, and private lenders, the system can assess how financing conditions impact buyer demand in different markets. This integration may enable more accurate demand forecasting by considering factors such as mortgage rate sensitivity and affordability thresholds. Additionally, the system may connect with public records databases to retrieve historical transaction records, property tax assessments, and zoning information, further refining its analysis of regional demand dynamics.

To incorporate broader economic indicators, the system may integrate with government and financial data providers such as the U.S. Census Bureau, Bureau of Labor Statistics, and Federal Reserve Economic Data (FRED). These sources provide essential macroeconomic variables, including employment rates, inflation, consumer confidence, and gross domestic product (GDP) growth, all of which influence housing demand. By ingesting this data, the system can adjust its demand predictions to reflect economic shifts that affect purchasing power and investment trends in the real estate sector.

The system may further enhance its predictive accuracy by communicating with online consumer behavior tracking platforms and social sentiment analysis tools. APIs from Google Trends, social media platforms, and online real estate search portals allow the system to assess real-time buyer interest and sentiment shifts. By monitoring search frequency for terms related to home buying, mortgage rates, and specific neighborhoods, the system can identify emerging trends in demand before they materialize in transaction data. Additionally, the system may interface with customer relationship management (CRM) platforms used by real estate agencies and property developers to analyze lead conversion rates, customer inquiries, and engagement patterns. This integration enables developers to optimize marketing strategies and sales efforts based on predictive insights.

Construction and development management platforms may also serve as integration points for the system, providing data on new project timelines, building permits, and construction progress. APIs from project management tools used in real estate development may allow the system to factor in supply-side constraints and anticipated inventory increases. This data is particularly useful for forecasting demand in pre-construction or newly launched developments where historical sales performance is limited.

Finally, the system may integrate with cloud-based data analytics and visualization platforms, enabling seamless reporting and decision-making. By connecting with business intelligence tools, the system can provide interactive dashboards and data-driven insights to stakeholders. These integrations support dynamic visualization of demand curves, pricing strategies, and market forecasts, empowering developers and investors to make data-driven decisions with real-time updates.

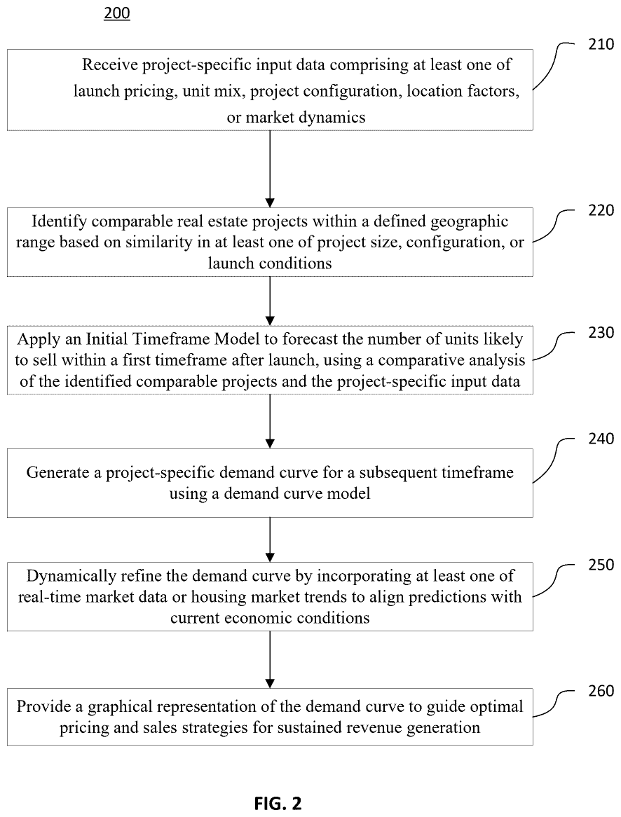

These and other features of demand prediction system 100 will be further understood with reference to the demand prediction method 200 of FIG. 2, herein.

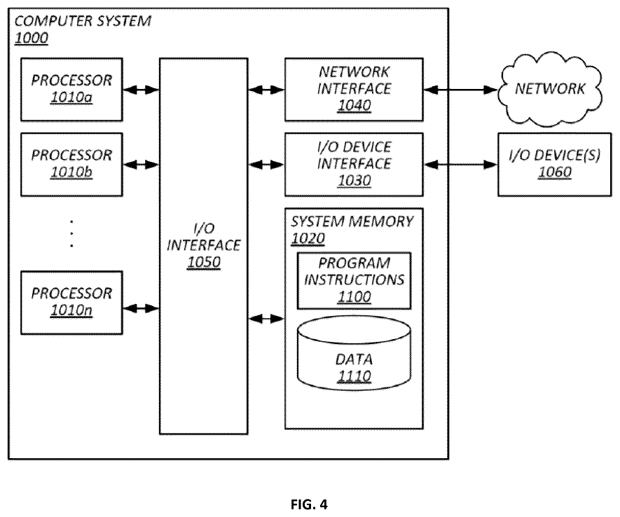

FIG. 2 depicts an example method for predicting demand in real estate sales, in accordance with at least one embodiment. In various embodiments, method 200 may be implemented by a system, e.g., demand prediction system 100, executing code in one or more processors therein. For example, in some embodiments, method 200 may be performed on a computer (e.g., computer system 1000 of FIG. 4) having one or more processors (e.g., processor(s) 1010 of FIG. 4) and memory (e.g., system memory 1020 of FIG. 4), and one or more code sets, applications, programs, modules, and/or other software stored in the memory and executing in or executed by one or more of the processor(s).

Method 200 begins at step 210 when a processor (e.g., of server 110) is configured to receive project-specific input data comprising at least one of launch pricing, unit mix, project configuration, location factors, or market dynamics. Launch pricing refers to the initial price point set for units within a real estate project and may be influenced by various factors such as market conditions, competitor pricing, and developer objectives. For example, a developer may set an aggressive launch price below market value to stimulate demand and achieve rapid unit absorption, or alternatively, a premium pricing strategy may be employed to position the development as a high-value offering. The received data may further include details about proximity to at least one of public transportation, schools, or other key amenities. This information is crucial for assessing location desirability, as projects near high-demand infrastructure, such as metro stations, shopping centers, and educational institutions, tend to attract higher interest from potential buyers.

The processor may apply a preprocessing routine to clean and normalize the received data, ensuring uniformity across different data sources. This process may include handling missing values, standardizing measurement units, and transforming categorical variables into numerical representations. Additionally, the processor may apply feature selection algorithms such as Principal Component Analysis (PCA) to retain only the most relevant variables, thereby reducing computational complexity in subsequent steps. PCA works by identifying the principal components that capture the most variance in the data, effectively condensing multiple correlated variables into a smaller set of uncorrelated factors. For instance, instead of treating proximity to multiple amenities as separate variables, PCA may consolidate them into a single factor representing overall accessibility.

In some embodiments, at step 220, the processor may identify comparable real estate projects within a defined geographic range based on similarity in at least one of project size, configuration, or launch conditions. This process may involve executing a weighted k-nearest neighbors (k-NN) algorithm, where similarity metrics are calculated using a combination of Euclidean distance for numerical attributes and categorical encoding for non-numeric attributes. The processor may then filter the identified comparables by applying an outlier detection mechanism, such as Isolation Forest, to remove anomalous data points that could distort similarity analysis. In other embodiments, the processor may iteratively refine its selection criteria by gradually expanding the search radius while filtering out statistically irrelevant outliers, ensuring that only meaningful comparable projects are retained. Further embodiments may utilize an advanced clustering technique, such as DBSCAN or hierarchical clustering, to segment the dataset into market-relevant categories before selecting comparables, thereby improving the accuracy of predictions.

In additional embodiments, the processor may use a dynamic weighting mechanism that assigns different levels of importance to various project attributes when identifying comparables. For example, in markets where unit mix plays a significant role, the weighting may prioritize unit configurations over location-based factors, whereas in areas with strong geographical pricing influences, proximity-based attributes may be given more significance. Another alternative approach may involve leveraging natural language processing (NLP) techniques to analyze property descriptions and extract key features for similarity comparison, allowing the system to incorporate qualitative aspects of a project, such as luxury features or sustainable design elements, into the similarity analysis.

In some implementations, the processor may also integrate real-time market fluctuations into the similarity analysis by dynamically adjusting the comparable selection criteria based on active listing trends, recent sales velocity, and buyer sentiment extracted from real estate platforms. For instance, if a sudden price shift occurs in a neighboring project, the model may automatically adjust the weighting of comparable pricing to reflect real-time demand patterns. Furthermore, in cases where a project has unique attributes that limit the number of direct comparables, the processor may employ a synthetic data generation approach, using generative adversarial networks (GANs) or other statistical modeling techniques to create hypothetical comparable projects that align with historical sales patterns.

In some embodiments, an alternative approach may involve a multi-stage filtering process where the system first narrows down potential comparables using strict primary filters, such as geographic proximity and project configuration, and then refines the selection further based on secondary attributes such as developer reputation, marketing strategies, or financing structures offered to buyers. This multi-stage process ensures that the final set of comparables provides the most statistically relevant insights for forecasting demand.

In some embodiments, at step 230, the processor may apply an Initial Timeframe Model to forecast the number of units likely to sell within a first timeframe after launch, which may be at least one of a first day, a first week, a first weekend, a first month, or a first defined period of time. This prediction is based on a comparative analysis of the identified comparable projects and the project-specific input data. The Initial Timeframe Model may be a supervised machine learning model trained on historical sales data from similar projects and may include outlier detection to exclude anomalous data from comparative analysis. Additionally, the Initial Timeframe Model may factor in the competitive landscape by analyzing the supply and pricing of similar projects launched within a six-month period prior to the subject project. By integrating recent competitor trends, the model ensures that developers have a realistic benchmark for expected absorption rates.

In further embodiments, the processor may implement a hybrid forecasting model that combines statistical regression techniques, such as autoregressive integrated moving average (ARIMA), with deep learning architectures, such as recurrent neural networks (RNN) or transformers, to capture both short-term trends and complex temporal dependencies. The model may continuously refine its predictions by integrating real-time sales data and recalibrating weightings based on market fluctuations. Additionally, the Initial Timeframe Model may incorporate external factors, such as mortgage rate changes, macroeconomic indicators, and buyer sentiment analysis from real estate forums or social media, to enhance predictive accuracy.

In some embodiments, at step 240, the processor may generate a project-specific demand curve for a subsequent timeframe, which may be at least one of a second day, a second week, a second weekend, a second month, multiple subsequent months, or a second predefined period of time, using a demand curve model. This model establishes a relationship between unit pricing and demand by iteratively analyzing data from comparable projects and adjusting for at least one of geographic or demographic variables. In alternative embodiments, the processor may employ a dynamic fitting algorithm that continuously expands the search radius for comparable projects while iteratively refining the data set by excluding statistically irrelevant outliers. Further embodiments may incorporate adjustments for seasonality trends in real estate sales, recognizing that different times of the year exhibit varying levels of buyer activity. For example, demand during the spring season may be significantly higher than during the winter months due to increased buyer interest.

In other implementations, the processor may generate separate demand curves for different unit types, such as one-bedroom, two-bedroom, and three-bedroom units, allowing for more precise pricing strategies tailored to specific buyer segments. The demand curve model may integrate hierarchical Bayesian techniques to capture uncertainties and provide probability distributions for different pricing scenarios. Additionally, reinforcement learning methods may be used to simulate multiple pricing strategies and identify optimal price points that maximize long-term revenue.

In some embodiments, at step 250, the processor may dynamically refine the demand curve by incorporating at least one of real-time market data or housing market trends to align predictions with current economic conditions. The processor may execute a Market Signal Processing and Adaptive Learning (MSPAL) algorithm, which continuously ingests and processes market indicators such as online real estate search trends, social sentiment analysis, and recent transaction data. In other embodiments, the processor may implement a federated learning approach where decentralized data sources contribute to model updates without requiring centralized storage, thereby improving scalability while maintaining data privacy.

In further embodiments, the demand curve may be continuously updated using reinforcement learning techniques that reward strategies maximizing sales velocity while minimizing inventory stagnation. The processor may apply an event-based processing pipeline that triggers demand curve adjustments based on predefined thresholds, such as a sudden increase in unit reservations or a drop in inquiry rates. Additionally, the system may integrate economic forecasting models that leverage macroeconomic indicators, such as employment rates and inflation, to adjust demand projections in response to external economic shifts.

In some implementations, the demand curve refinement process may incorporate a best-selling path optimization module that simulates various pricing sequences, promotional strategies, and phased unit releases to determine the most profitable trajectory for maximizing developer revenue. The processor may generate real-time reports summarizing demand curve trends, optimal pricing scenarios, and risk factors associated with different sales strategies. Furthermore, an automated scenario analysis engine may evaluate different unit mix configurations, price segmentation strategies, and incentive structures to identify the most profitable development plan based on projected demand and competitor benchmarking.

In some embodiments, at step 260, the processor may provide a graphical representation of the demand curve to guide optimal pricing and sales strategies for sustained revenue generation. The processor may execute a visualization module that generates an interactive graphical user interface (GUI), displaying the demand curve with adjustable parameters for real-time scenario testing. In other embodiments, the GUI may incorporate an AI-driven recommendation engine that suggests optimal pricing strategies based on historical performance and predicted demand elasticity.

Further embodiments may include interactive forecasting tools that allow developers to simulate different demand scenarios by adjusting pricing, promotional efforts, and market conditions in a real-time environment. The visualization module may also feature heatmap overlays that highlight optimal pricing regions, enabling developers to make informed decisions about adjusting prices in response to demand fluctuations. Additionally, the interface may integrate augmented reality (AR) or virtual reality (VR) components, allowing users to visualize sales patterns and demand curves in an immersive 3D environment.

In some implementations, the graphical representation may incorporate a predictive analytics dashboard that visualizes not only demand curves but also competitive market positioning, historical sales trajectories, and forecast confidence intervals. The dashboard may provide alerts when significant deviations in demand predictions occur, prompting users to take immediate action by adjusting pricing or marketing strategies. Furthermore, the system may generate automated reports summarizing demand curve trends, performance insights, and suggested optimizations, ensuring that decision-makers have a comprehensive understanding of market conditions.

The multi-part demand prediction system, which consists of at least an Initial Timeframe Model and the Subsequent Timeframe Demand Curve Model, may be implemented in various industries beyond real estate to provide accurate demand forecasting. Each industry may leverage the system's ability to forecast short-term sales performance through the Initial Timeframe Model while using the Subsequent Timeframe Demand Curve Model to predict and adjust for long-term trends.

In the retail industry, the Initial Timeframe Model may be used to predict the immediate demand for newly launched products based on historical sales data, competitor pricing, seasonal trends, and marketing campaigns. For example, when a new consumer electronics product, such as a smartphone or gaming console, is introduced, the system may predict the number of units expected to sell within the first few days or weeks after launch. The model may analyze data from comparable product releases, pricing elasticity, and promotional efforts to refine the short-term demand forecast. The Subsequent Timeframe Demand Curve Model may then be used to forecast sales over the coming months by continuously analyzing new purchase data, customer reviews, competitor reactions, and supply chain constraints. This allows retailers and manufacturers to adjust production volumes, distribution strategies, and pricing models dynamically.

In the transportation and logistics sector, the two-part prediction model may optimize fleet deployment and resource allocation. The Initial Timeframe Model may estimate passenger or freight demand immediately after the launch of a new transportation route, ride-sharing service, or delivery program. For example, when a ride-sharing company introduces a new service in a metropolitan area, the system may predict ride volume for the first week by analyzing similar city launches, demographic data, and economic conditions. The Subsequent Timeframe Demand Curve Model may then adjust the forecast based on real-time ride data, fuel costs, road congestion, and seasonal commuting patterns. This approach allows transportation providers to modify pricing, fleet distribution, and promotional strategies to optimize profitability and efficiency.

In the healthcare sector, the Initial Timeframe Model may be used to predict patient influx following the introduction of a new medical service, such as a vaccination program or urgent care facility. The system may analyze historical patient data, regional disease prevalence, and public health policies to estimate the number of expected visits in the first few weeks. The Subsequent Timeframe Demand Curve Model may then track ongoing patient visits, seasonal illness trends, and emerging public health threats to refine demand predictions over time. This allows healthcare providers to adjust staffing, allocate medical supplies efficiently, and optimize resource distribution based on actual patient needs.

In the financial services industry, banks and lending institutions may apply the two-part prediction model to forecast demand for loan products, credit cards, or investment services. The Initial Timeframe Model may estimate the number of mortgage or auto loan applications following an interest rate adjustment or promotional offer. The system may use historical lending trends, borrower credit profiles, and macroeconomic conditions to generate initial projections. The Subsequent Timeframe Demand Curve Model may then refine these projections by continuously analyzing new loan applications, default rates, and borrower sentiment. This enables financial institutions to dynamically adjust lending policies, interest rates, and risk assessment strategies in response to evolving market conditions.

In the supply chain and manufacturing industries, the Initial Timeframe Model may be used to predict demand surges for newly released products or materials. For example, when a major retailer announces a limited-time sale on consumer goods, the system may estimate immediate demand based on similar past promotions, consumer sentiment, and online search trends. The Subsequent Timeframe Demand Curve Model may then refine inventory and production forecasts by incorporating real-time sales data, supplier constraints, and geopolitical disruptions that may affect raw material availability. This approach ensures manufacturers and logistics providers can respond proactively to demand fluctuations while minimizing excess inventory costs.

In the hospitality and tourism industry, the Initial Timeframe Model may predict bookings for newly launched hotels, resorts, or travel packages based on historical travel trends, competitive pricing, and seasonal factors. For example, when a new luxury resort opens, the system may estimate guest reservations for the first month by analyzing comparable properties, economic conditions, and customer booking behavior. The Subsequent Timeframe Demand Curve Model may then adjust future occupancy predictions by integrating real-time reservation data, changes in airline pricing, and macroeconomic indicators such as disposable income and employment rates. This enables hotels and travel agencies to optimize room pricing, marketing spend, and guest experiences in response to changing demand patterns.

By applying the two-part demand prediction system across these industries, organizations may gain real-time insights into short-term and long-term demand patterns. The ability to adjust forecasts dynamically based on market reactions, economic conditions, and consumer behavior allows for more accurate decision-making, optimized resource allocation, and enhanced profitability.

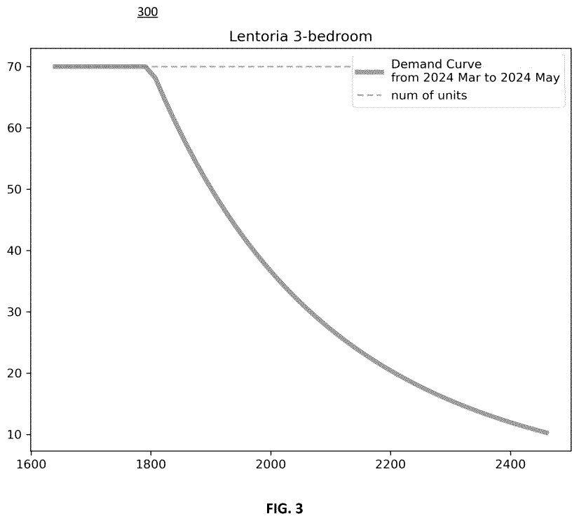

Turning briefly to FIG. 3, a representative demand curve 300 is shown on an interface in accordance with at least one embodiment.

Some embodiments may execute the above operations on a computer system, such as the computer system of FIG. 4, which is a diagram that illustrates a computing system 1000 in accordance with embodiments of the present techniques. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, external (e.g., third party) content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B may include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and may be implemented in the form of data that causes functionality to be invoked, e.g., in the form of arguments of a function or API call. To the extent bespoke noun phrases are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

While the systems and methods described herein have generally be described with respect to a single legacy language being translated to a modernized coding language (e.g., one-to-one translation of a first language to a second language), in various embodiments, the same processes may be implemented in a one-to-many framework. For example, in some embodiments, a user may indicate one or more second languages to which a first language is to be translated. Additionally or alternatively, in some embodiments, one or more translation recommendations may be provided (as described herein) for multiple translations. In either event, embodiments of the systems and methods described herein may be configured to process multiple translations, e.g., in parallel and/or in series (e.g., based on an identified priority), as described herein.

This written description uses examples to disclose the implementations, including the best mode, and to enable any person skilled in the art to practice the implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for predicting demand in real estate sales, the method comprising:
receiving project-specific input data comprising at least one of launch pricing, unit mix, project configuration, location factors, or market dynamics;
identifying comparable real estate projects within a defined geographic range based on similarity in at least one of project size, configuration, or launch conditions;
applying an Initial Timeframe Model to forecast the number of units likely to sell within a first timeframe after launch, using a comparative analysis of the identified comparable projects and the project-specific input data;
generating a project-specific demand curve for a subsequent timeframe using a demand curve model, wherein the model establishes a relationship between unit pricing and demand by iteratively analyzing data from the comparable projects and adjusting for at least one of geographic or demographic variables;
dynamically refining the demand curve by incorporating at least one of real-time market data or housing market trends to align predictions with current economic conditions; and
providing a graphical representation of the demand curve to guide optimal pricing and sales strategies for sustained revenue generation.

2. The method of claim 1, wherein the project-specific input data further includes details about proximity to at least one of public transportation, schools, or other key amenities.

3. The method of claim 1, wherein the Initial Timeframe Model implements outlier detection to exclude anomalous data from the comparative analysis.

4. The method of claim 1, wherein the demand curve model utilizes a dynamic fitting algorithm that gradually expands the search radius for comparable projects while iteratively refining the data set by excluding statistically irrelevant outliers.

5. The method of claim 1, wherein the demand curve is adjusted to reflect macroeconomic indicators, comprising at least one of interest rates, inflation, or housing demand trends.

6. The method of claim 1, wherein the project-specific demand curve includes separate sub-curves for different unit types.

7. The method of claim 1, wherein the graphical representation of the demand curve is interactive, enabling real estate developers to simulate the effects of varying price points on projected demand.

8. The method of claim 1, wherein the Initial Timeframe Model predicts sales performance based on the competitive landscape, including the supply and pricing of similar projects launched within a six-month period prior to the subject project.

9. The method of claim 1, wherein the demand curve model incorporates adjustments for seasonality trends in real estate sales to improve demand forecasting accuracy.

10. The method of claim 1, further comprising continuously updating the demand curve using one or more machine learning techniques as at least one of new sales or market data become available.

11. The method of claim 1, further comprising generating a comprehensive report summarizing at least one of predicted sales rates, demand curve insights, or recommended pricing strategies.

12. The method of claim 1, wherein the first timeframe after launch is at least one of a first day, a first week, a first weekend, a first month, or a first defined period of time.

13. The method of claim 1, wherein the subsequent timeframe is at least one of a second day, a second week, a second weekend, a second month, multiple subsequent months, or a second predefined period of time.

14. The method of claim 1, further comprising the integrating real estate market data, comprising at least one of the number of visitors to open house events, agent and agency commission structures, or online real estate search trends.

15. The method of claim 1, wherein the method extends beyond residential real estate to commercial, industrial, and mixed-use developments, incorporating specific market dynamics for each segment.

16. The method of claim 1, further comprising a best-selling path optimization module that utilizes the demand curve, real-time market data, and historical transaction trends to determine the optimal sequence of unit releases, pricing adjustments, and promotional strategies to maximize revenue and sales velocity.

17. The method of claim 1, further comprising an automated scenario analysis engine that evaluates different unit mix configurations, price segmentation strategies, and incentive structures to identify the most profitable development plan based on projected demand and competitor benchmarking.

18. The method of claim 17, wherein the optimization strategy is customized to align with developer-specific objectives, such as achieving a target sales percentage within a predefined timeframe, maintaining price stability without reductions, or maximizing long-term revenue potential.

19. A system for predicting demand in real estate sales, comprising:
memory storing computer program instructions; and
one or more processors configured to execute the computer program instructions to:
receive project-specific input data comprising at least one of launch pricing, unit mix, project configuration, location factors, or market dynamics;
identify comparable real estate projects within a defined geographic range based on similarity in at least one of project size, configuration, or launch conditions;
apply an Initial Timeframe Model to forecast the number of units likely to sell within a first timeframe after launch, using a comparative analysis of the identified comparable projects and the project-specific input data;
generate a project-specific demand curve for a subsequent timeframe using a demand curve model, wherein the model establishes a relationship between unit pricing and demand by iteratively analyzing data from the comparable projects and adjusting for at least one of geographic or demographic variables;
dynamically refine the demand curve by incorporating at least one of real-time market data or housing market trends to align predictions with current economic conditions; and
provide a graphical representation of the demand curve to guide optimal pricing and sales strategies for sustained revenue generation.

20. A non-transitory computer readable medium having instructions recorded thereon for predicting demand in real estate sales, the instructions when executed by a computer having at least one programmable processor cause operations comprising:
receiving project-specific input data comprising at least one of launch pricing, unit mix, project configuration, location factors, or market dynamics;
identifying comparable real estate projects within a defined geographic range based on similarity in at least one of project size, configuration, or launch conditions;
applying an Initial Timeframe Model to forecast the number of units likely to sell within a first timeframe after launch, using a comparative analysis of the identified comparable projects and the project-specific input data;
generating a project-specific demand curve for a subsequent timeframe using a demand curve model, wherein the model establishes a relationship between unit pricing and demand by iteratively analyzing data from the comparable projects and adjusting for at least one of geographic or demographic variables;
dynamically refining the demand curve by incorporating at least one of real-time market data or housing market trends to align predictions with current economic conditions; and
providing a graphical representation of the demand curve to guide optimal pricing and sales strategies for sustained revenue generation.
